(19) United States
(12) Patent Application Publication
(10) Pub. No.: US 2026/0186499 A1
(43) Pub. Date: Jul. 2, 2026

(54) MANAGEMENT SYSTEM AND MANAGEMENT METHOD

(71) Applicant: TOYOTA JIDOSHA KABUSHIKI KAISHA, Toyota-shi (JP)

(72) Inventors: Yoshiki UEDA, Toyota-shi (JP); Osamu Taniai, Toyota-shi (JP); Shiro Oda, Toyota-shi (JP)

(73) Assignee: TOYOTA JIDOSHA KABUSHIKI KAISHA, Toyota-shi (JP)

(21) Appl. No.: 19/407,200

(22) Filed: Dec. 3, 2025

(30) Foreign Application Priority Data
Dec. 27, 2024 (JP) 2024-231746

(51) Int. Cl. G05D 1/622; G05D 1/229; G05D 1/246; G05D 1/693; G05D 107/70; G05D 109/10; G05D 111/30

(52) U.S. Cl. CPC G05D 1/622; G05D 1/2295; G05D 1/246; G05D 1/693; G05D 2107/70; G05D 2109/10; G05D 2111/32

(57) ABSTRACT

A management system according to an embodiment is a management system including a server configured to manage a plurality of autonomous moving objects that travels within a facility. The management system is configured to: divide a map of the facility into a plurality of areas based on map information indicating the map; set at least one of the areas as a restricted area and at least one of the areas as a non-restricted area; and in the restricted area, permit passage of an autonomous moving object to which right-of-way that permits passage through the restricted area is granted, and restrict passage of an autonomous moving object to which the right-of-way is not granted.

### CROSS-REFERENCE TO RELATED APPLICATION

This application claims priority to Japanese Patent Application No. 2024-231746 filed on Dec. 27, 2024. The disclosure of the above-identified application, including the specification, drawings, and claims, is incorporated by reference herein in its entirety.

### BACKGROUND

### 1. Technical Field

The present disclosure relates to management systems and management methods.

### 2. Description of Related Art

Japanese Unexamined Patent Application Publication No. 2024-17484 (JP 2024-17484 A) discloses a management system that manages the passage of moving objects that travel autonomously. This system manages resources necessary for the passage of the moving objects. The system allocates resources in response to requests from the moving objects. Further, a building is divided into a plurality of sub-areas, and resources are allocated for each sub-area.

### SUMMARY

For such a moving object management system, there is a demand to manage multiple moving objects in a simple manner such that the moving objects can move efficiently.

A management system according to an embodiment is a management system including a server configured to manage a plurality of autonomous moving objects that travels within a facility. The management system is configured to: divide a map of the facility into a plurality of areas based on map information indicating the map; set, based on the areas, at least one restricted area and at least one non-restricted area on the map; and in the restricted area, permit passage of an autonomous moving object to which right-of-way that permits passage through the restricted area is granted, and restrict passage of an autonomous moving object to which the right-of-way is not granted.

A management method according to an embodiment is a method for managing a plurality of autonomous moving objects that travels within a facility by using a computer. The method includes causing the computer to: divide a map of the facility into a plurality of areas based on map information indicating the map; set, based on the areas, at least one restricted area and at least one non-restricted area on the map; and in the restricted area, permit passage of an autonomous moving object to which right-of-way that permits passage through the restricted area is granted, and restrict passage of an autonomous moving object to which the right-of-way is not granted.

The present disclosure can provide a management system and a management method that can manage moving objects such that the moving objects can move efficiently.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating the overall configuration of a management system according to an embodiment;

FIG. 2 is a block diagram illustrating a control system of the management device;

FIG. 3 is a diagram illustrating restricted areas and waypoints set in map information of a facility;

FIG. 4 is a diagram illustrating restricted areas and waypoints set in map information of the facility;

FIG. 5 is a diagram illustrating restricted areas and non-restricted areas set in map information of a facility; and

FIG. 6 is a flowchart illustrating a management method.

### DETAILED DESCRIPTION OF EMBODIMENTS

The present disclosure will now be described below through an embodiment. However, the disclosure according to the claims is not limited to the embodiment described below. In addition, not all of the configurations described in the embodiment are necessarily essential as means for addressing the issues.

### Overall Configuration

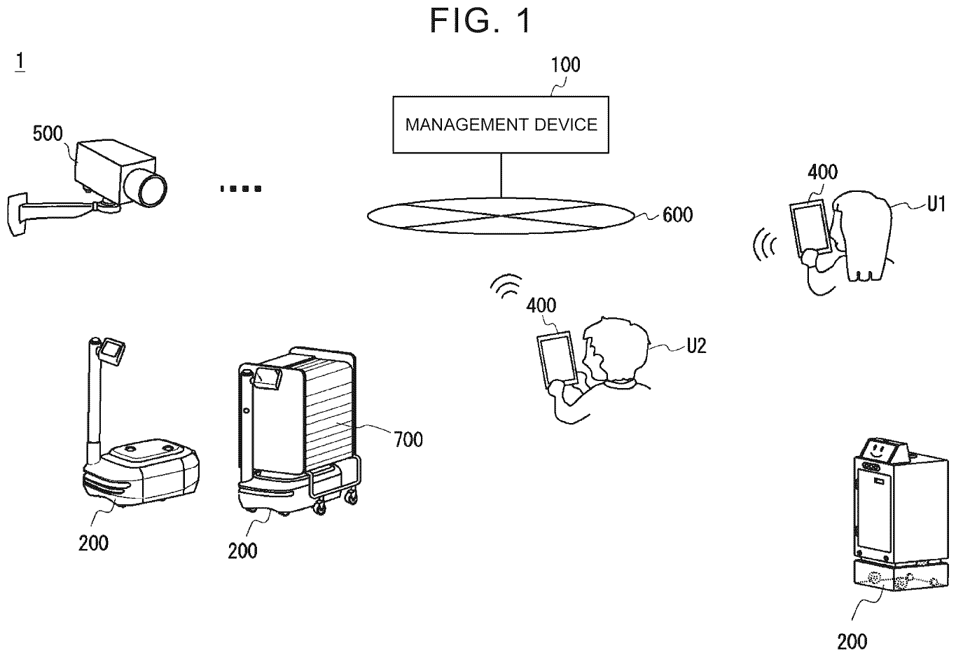

The management system according to the present embodiment is a system for managing autonomous moving objects. FIG. 1 is a schematic diagram illustrating the configuration of a management system 1. The management system 1 is a system for managing a plurality of robots 200. The management system 1 includes a management device 100, the robots 200, a camera 500, a network 600, user terminals 400, and an auxiliary unit 700. The management device 100 manages the passage and tasks of the robots 200.

The robots 200 are autonomous moving objects that execute a task such as a transport task. The robots 200 move autonomously in medical and welfare facilities such as hospitals, rehabilitation centers, nursing homes, and senior residences. The robots 200 are used to transport pharmaceuticals, medical devices, meals, tableware, medical records, supplies, specimens, linens, people, etc. The object to be transported may be a person such as a patient. The system according to the present embodiment is also applicable to commercial facilities such as shopping malls. Each of the robots 200 is provided with wheels, a chassis, a motor, sensors, a battery, and a controller. At least one of the robots 200 is of a different type. All the robots 200 may be of the same type. Each of the robots 200 is assigned a unique identification number (ID). Although three robots 200 are illustrated in FIG. 1, the number of robots is not particularly limited as long as there are two or more robots.

At least one of the robots 200 may execute a task other than a transport task. Examples of other tasks include cleaning tasks, security tasks, and guiding tasks. The robot 200 may execute multiple tasks such as cleaning, security, and guiding by using the auxiliary unit 700, or may execute tasks independently. For example, various tasks can be executed by the robot 200 when the auxiliary unit 700 is used in combination with the robot 200. The robot 200 may be equipped with different accessory units depending on the task. By replacing the auxiliary unit 700, the robot 200 becomes a multitasking robot that can execute multiple tasks.

In the case of a transport task, the auxiliary unit 700 is a wheeled cart or wagon that carries an object to be transported (hereinafter also referred to as “transport object”). In the case of a cleaning task, the auxiliary unit 700 is provided with a vacuum cleaner that sucks in dust etc. In the case of a security task, the auxiliary unit 700 is equipped with sensors such as Light Detection and Ranging (LiDAR) and cameras. In the following description, the robot 200 will be described as mainly executing a transport task.

A user U1 or a user U2 can use the user terminal 400 to make a task request such as a request to transport an object. For example, the user terminal 400 may be a tablet computer or a smartphone. The user terminal 400 may be any information processing device as long as it can communicate wirelessly or by wire.

In the present embodiment, the robots 200 and the user terminals 400 are connected to the management device 100 via the network 600. The network 600 is a wired or wireless local area network (LAN) or wide area network (WAN). The management device 100 is connected to the network 600 via a wired or wireless connection. For example, communication between the devices may use a general-purpose communication standard such as Wi-Fi (registered trademark).

Various signals transmitted from the user terminals 400 of the users U1, U2 are first sent to the management device 100 via the network 600, and then forwarded from the management device 100 to the target robot 200. Similarly, various signals transmitted from the robot 200 are first sent to the management device 100 via the network 600, and then transferred from the management device 100 to the target user terminal 400. The management device 100 is a server connected to each device and collects data from the devices. The management device 100 is not limited to being a single physical device, and may include multiple devices that perform distributed processing. The management device 100 may alternatively be distributed across edge devices such as the robots 200. For example, part or all of the management system 1 may be installed among the robots 200.

Each of the robots 200 is provided with a drive motor, wheels, a battery, etc. The robot 200 is also equipped with sensors such as cameras and LiDAR device, and a processing unit such as a processor. The robot 200 estimates its own position based on detection results from the sensors. The robot 200 autonomously travels along a route on a map from a departure point to a destination, based on its own position. The departure point is the current position of the robot, and the destination is the delivery destination of the transport object. A route search may be performed using, for example, the pickup location of the transport object as an intermediate point. Either the management device 100 or the robot 200 may perform the route search from the departure point to the destination.

The user terminal 400 and the robot 200 may transmit and receive signals without going through the management device 100. For example, the user terminal 400 and the robot 200 may directly transmit and receive signals via wireless communication. The management device 100 may also collect data from the camera 500. The camera 500 may be a surveillance camera or a security camera. The management device 100 may also collect data from communication devices and sensors that are not shown.

It is herein assumed that multiple types of robots 200 are used in a facility. The management device 100 assigns tasks to each of the robots 200. Each of the robots 200 may be equipped with an auxiliary unit 700 corresponding to the assigned task to execute the task. The task to be executed by the robot 200 may be input by the user U1 or U2, or may be scheduled in advance. For example, a user such as the user U1 makes a task request by operating the user terminal 400. A user such as the user U1 can input the type of task to be executed. A user such as the user U1 may input the area or time period for executing the task. The management device 100 prepares a schedule for the robots 200 to efficiently execute tasks.

The user U1 or U2 may operate the user terminal 400 to request a transport task. In this case, the user U1 or U2 inputs information regarding the transport object. The user U1 or U2 may also input arrival schedule information indicating the expected arrival of the transport object. The management device 100 assigns a robot to execute the transport task based on expected arrival schedule information. The management device 100 then transmits a control signal for the robot to execute the task. The control signal may include transport object information indicating the route to the destination and the transport object.

In such an overall configuration, the elements of the management system 1 can be distributed among the robots 200, the user terminals 400, and the management device 100 to collectively construct the management system 1. Alternatively, the core elements for implementing the transport of objects may be integrated into a single device.

### Control System

The management device 100 includes a server computer, and performs computations for controlling and managing the robots 200. For example, the management device 100 can be implemented as a device capable of executing programs, such as a central processing unit (CPU) of a computer. The functions described later may also be implemented by a program. The management device 100 manages the transport objects based on their transport object IDs, and manages the robots 200 based on their robot IDs.

For example, the management device 100 manages the schedules of the robots 200 so as to allow the robots 200 to efficiently execute tasks. For example, when the management device 100 receives a task request from the user terminal 400 etc., it selects one robot 200 from among the robots 200 and instructs the robot 200 to execute the task. Alternatively, the management device 100 instructs the robot 200 which auxiliary unit 700 to use.

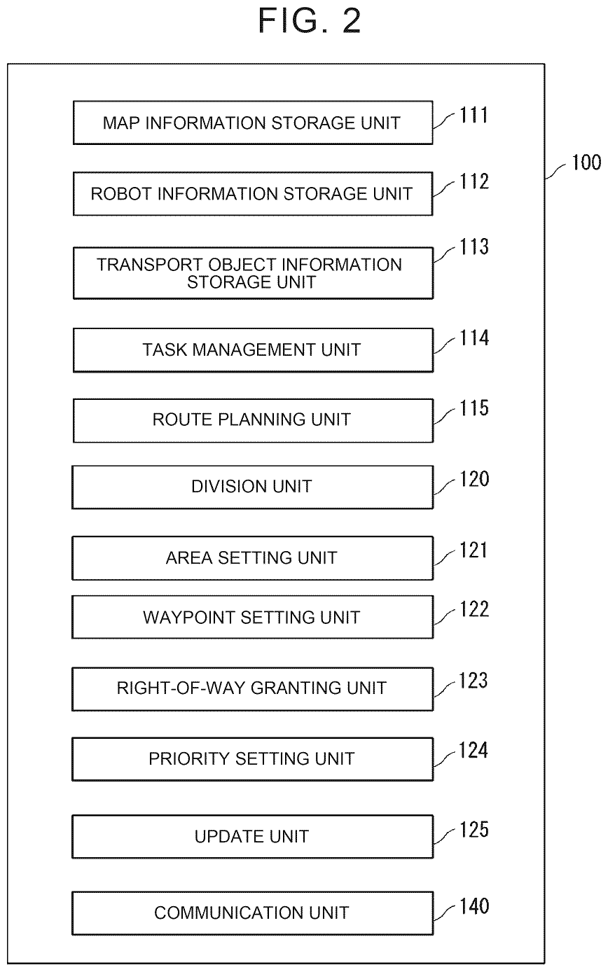

FIG. 2 is a block diagram illustrating a control system of the management device 100 according to the present embodiment. As shown in FIG. 2, the management device 100 includes a map information storage unit 111, a robot information storage unit 112, a transport object information storage unit 113, a task management unit 114, and a route planning unit 115. The management device 100 further includes a division unit 120, an area setting unit 121, a waypoint setting unit 122, a right-of-way granting unit 123, a priority setting unit 124, an update unit 125, and a communication unit 140. The functional blocks shown in FIG. 2 are by way of example, and the management device 100 may include other functional blocks. Alternatively, the management device 100 may not include part of the functional blocks shown in FIG. 2. Part of the functions may be performed by the robot 200.

The map information storage unit 111 stores map information indicating a floor map of the facility (also referred to simply as “map”). The map information may include information on restricted areas and waypoints, which will be described later. The map information may be created in advance. The map information may be map information that includes part of an area in which the service is scheduled to be executed, rather than a floor map of the entire facility. Each robot refers to the map information and autonomously travels to the destination. The map information may be generated based on architectural drawings, computer-aided design (CAD) data, building information modeling (BIM) data, etc. Alternatively, the map information may be generated based on measurement results from a distance sensor such as LiDAR.

The robot information storage unit 112 stores robot information. The robot information includes information on the robots 200 operating in the facility. The robot information includes information such as the model number of the robot 200, executable services, types of transportable objects, and attachable auxiliary units 700. The robot information storage unit 112 stores the robot information in the form of a database in which various types of information are stored for each robot ID. The robot information may include information on the current position of the robot, the travel route, whether the robot is executing a task or is in an idle state, and information on the task being executed. The robot information may include information on the auxiliary unit in use or the object being transported.

The transport object information storage unit 113 stores transport object information related to transport objects. For example, the transport object information includes an identification number (ID) of a transport object, the content (type) of the transport object, a pickup location, a delivery destination, a pickup time, or an arrival time. The transport object information 126 indicates whether the transport object is a pharmaceutical, medical device, meal, tableware, medical record, supply, specimen, linen, or a person. The transport object information 126 may include information such as the size or weight of the transport object. The transport object information may include information indicating a status such as “in transport,” “before transport (before loading),” or “transport completed.” The transport object information storage unit 113 stores the transport object information in the form of a database in which such information is associated with each transport object ID. When a new transport request is made from the user terminal 400, transport object information is added. After completion of the transport, the information related to the transport object may be deleted from the list.

The task management unit 114 manages tasks executed by the robots 200. For example, the user U1 inputs transport object information indicating a transport object, a pickup location, and a delivery destination, and makes a transport task request. The task management unit 114 assigns the transport task to a robot 200. For example, the task management unit 114 extracts a robot capable of executing the task. When some robots 200 are unable to transport the transport object specified in the transport request, the task management unit 114 excludes those robots 200 and extracts the robots 200 capable of executing the task.

The task management unit 114 extracts a robot 200 capable of transporting the transport object from among the robots 200. The task management unit 114 then assigns the transport task to the extracted robot 200. When two or more robots are capable of transporting the transport object, the task management unit 114 selects a robot such that the transport service can be executed more efficiently. For example, the task management unit 114 assigns the task to a robot located near the pickup location. Alternatively, the task management unit 114 assigns the task to an idle robot that is not executing any other task. In this way, the task can be executed efficiently.

The task management unit 114 manages tasks executed by each robot 200, tasks being executed by each robot 200, and tasks scheduled to be executed by each robot 200. The task management unit 114 may also store various types of task information for each task as a database. The task management unit 114 may store, as task information, information indicating whether each robot 200 is executing a task or has completed a task. The task management unit 114 may also store, as task information, a transport start time at which transport is started, and a scheduled completion time of a task being executed. The task information may include transport information related to the transport object being transported. For example, the task information may include information such as the type of transport object, the delivery destination, and the pickup location. Alternatively, the task management unit 114 may store information indicating whether the auxiliary unit 700 is in use.

The route planning unit 115 plans a route for executing a task. For example, the route planning unit 115 searches for a route from the pickup location to the delivery destination for the robot 200 to which a task is assigned. Specifically, the route planning unit 115 searches for a route from the current position of the robot 200 to the pickup location. The pickup location is a loading location where the transport object is loaded. The route planning unit 115 also searches for a route from the pickup location to the delivery destination.

Waypoints set on the map are used for route searching. Waypoints are specified on the map as passing points through which the robot passes. The waypoints will be described later. The route searched by the route planning unit 115 is transmitted to the robot 200. At least part of the processing of the route planning unit 115 may be executed by the robot 200. When a congested area is identified based on images from surveillance cameras etc., the route planning unit 115 may search for a route that avoids the congested area. The route planning unit 115 may search for a route that allows travel in the shortest time or distance.

When waypoints corresponding to a departure point, a destination, and an intermediate point are input, the route planning unit 115 performs a route search. Through the route search, the waypoints to be passed and the order in which they are passed are specified. The communication unit 140 then transmits, to the robot 200, ID information and positions of the waypoints to be passed.

The division unit 120 divides the map into a plurality of areas. For example, the division unit 120 uses a segmentation algorithm that takes architectural data such as CAD data or BIM data as input. When, for example, image data indicating architectural data is input to the division unit 120, semantic segmentation or instance segmentation is used to classify passable locations and impassable locations. Impassable locations include locations with stairs, walls, or installed objects. Passable locations include corridors, halls, and rooms. The segmentation algorithm may be a deep learning model using a convolutional neural network (CNN) etc.

The division unit 120 may divide the map into a plurality of areas using a Voronoi tessellation. By using a Voronoi tessellation, it becomes possible to divide the map into appropriate areas. In a Voronoi tessellation, the space is divided into regions based on which site each point in the space is closest to. The boundary line of each area is part of the bisector between the seed points. In this way, multiple areas are formed on the map.

The area setting unit 121 sets at least one restricted area and at least one non-restricted area on the map based on these areas. For example, the area setting unit 121 sets restricted areas on the map. A restricted area is a region in which movement of the robots 200 is restricted. For example, a restricted area may be a region including intersections or branch points. Alternatively, a restricted area may be a narrow corridor in which two-way passage of the robots 200 is not possible. A robot 200 needs to have right-of-way in order to pass through a restricted area. That is, a robot 200 to which the right-of-way has not been granted cannot enter the restricted area and instead waits in front of the restricted area. On the map, regions other than restricted areas are non-restricted areas. A robot 200 does not need right-of-way to pass through a non-restricted area. The area setting unit 121 sets one or more restricted areas on the map. The area setting unit 121 also sets one or more non-restricted areas on the map.

The area setting unit 121 assigns an area ID to each of the restricted and non-restricted areas. The area setting unit 121 associates boundary lines or boundary coordinates with the area ID and stores them as area information. The area information may include information indicating attributes of restricted areas and non-restricted areas. For example, the attributes may include a corridor, an intersection, a branch point, an elevator hall, a hall, a room, an entrance/exit, a location for receiving transport objects, a loading location, an unloading location, a waiting location, and a charging location. The area information may also include information indicating the number of robots that can pass through at the same time. The restriction of passage is not limited to prohibition of simultaneous passage, but may include one-way passage or single-lane passage. The area setting unit 121 may change the area settings depending on the time of day or situation.

For example, the division unit 120 divides the map such that each room is treated as a different area. The area setting unit 121 then determines whether to designate each room as a restricted area according to the use, size, location, and layout of the room. The area setting unit 121 sets intersections and branch points in a corridor as restricted areas. The area setting unit 121 sets portions other than intersections and branch points as non-restricted areas. For example, the area setting unit 121 sets straight portions of a corridor as non-restricted areas.

The management device 100 or another computer may set restricted areas and non-restricted areas by arithmetic processing, or the user may set restricted areas and non-restricted areas. After restricted or non-restricted areas are set by arithmetic processing, the user may manually adjust the area settings. For example, by executing a program, a computer such as the management device 100 may set one or more restricted areas or one or more non-restricted areas. The user may manually set one or more restricted areas or one or more non-restricted areas.

By using a program for setting areas, simple area setting can be realized. Specifically, the computer classifies corridors and rooms based on architectural drawing data, map layout, or BIM data. When the computer identifies intersections, branch points, entrances/exits, waiting locations, corners, or narrow corridors, those locations are set as restricted areas. An artificial intelligence (AI) model generated by supervised learning etc. may be used for automatic setting of areas.

Image data representing architectural drawings or BIM data is used as input for the machine learning model. The machine learning model uses a segmentation algorithm to identify impassable locations such as walls or installed objects, and classifies rooms and corridors. The machine learning model determines whether passage should be restricted, and sets restricted areas. For example, the machine learning model sets narrow corridors, entrances/exits, waiting locations, branch points, and their surrounding areas as restricted areas. The machine learning model sets areas other than restricted areas on the map as non-restricted areas.

The area setting unit 121 may perform area setting using an algorithm other than a model obtained by machine learning. Alternatively, the movement of the robots may be monitored after they are put into operation. When a location where robots are likely to become unable to travel is identified, the area setting unit 121 may set that location as a restricted area. Manual setting and automatic setting may be combined.

The waypoint setting unit 122 sets waypoints on the map. A waypoint is a point through which the robot 200 passes. Waypoints are used for route planning. For example, the route planning unit 115 sets waypoints from a departure point to a destination and their order. The route planning unit 115 determines the order of waypoints to be passed. The robot 200 autonomously travels so as to pass the waypoints in the set order. For example, when a corridor branches at intersections and branch points, the waypoint setting unit 122 sets waypoints as appropriate at intersections, branch points, corners, and their surrounding positions. The waypoint setting unit 122 also sets waypoints in boundary portions of areas.

The waypoint setting unit 122 sets multiple waypoints on the map. The waypoint setting unit 122 assigns a waypoint ID to each waypoint. The waypoint setting unit 122 associates the coordinates of the waypoints with their IDs and stores them as waypoint information. The waypoint information may include attributes of the waypoints. The waypoint setting unit 122 may also set, as waypoints, a charger, the inside of an elevator, elevator boarding and alighting positions, a location for receiving transport objects, a location for loading transport objects, and the area in front of an automatic door.

The management device 100 or another computer may set waypoints by arithmetic processing, or the user may set them. After waypoints are set by arithmetic processing, the user may manually adjust the waypoint settings. For example, one or more waypoints may be set by execution of a program by the management device 100 or another computer. The user may manually set waypoints.

By using a program for setting waypoints, simple waypoint setting can be realized. Specifically, when the computer identifies intersections etc. based on architectural drawing data, map layout, CAD data, or BIM data, the waypoint setting unit 122 sets waypoints at those locations. Alternatively, the waypoint setting unit 122 sets waypoints in boundary portions between restricted areas and non-restricted areas. An AI model generated by supervised learning etc. may be used for automatic waypoint setting.

Image data representing architectural drawings or BIM data is used as input for the machine learning model. Map data in which areas have been set is also used as input to the machine learning model. The machine learning model sets waypoints using a segmentation algorithm. Manual setting and automatic setting may be combined.

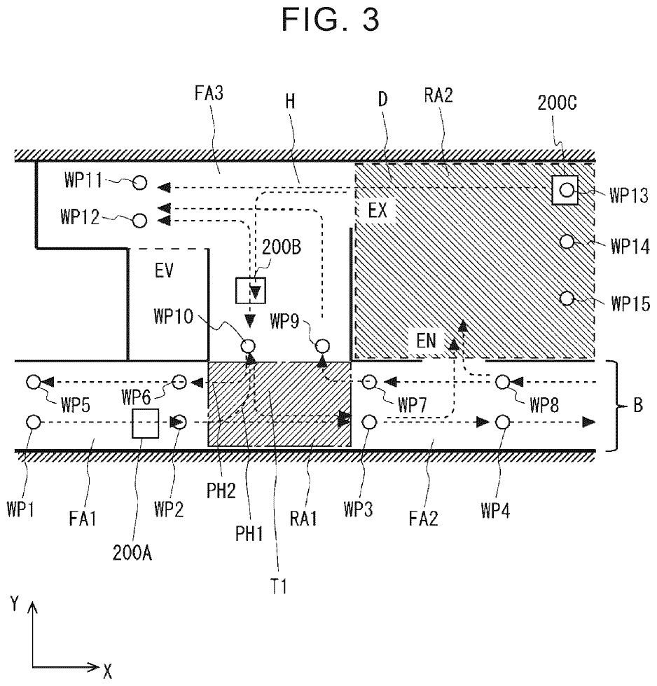

Restricted areas, non-restricted areas, and waypoints set on a map will be described with reference to FIG. 3. FIG. 3 is a plan view schematically showing the map. In FIG. 3, restricted areas RA1, RA2 and non-restricted areas FA1, FA2, and FA3 are included on the map. FIG. 3 also shows an XY two-dimensional orthogonal coordinate system for clarity of description. In FIG. 3, three robots 200 are shown, which are identified as robots 200A, 200B, and 200C. When the robots 200A, 200B, and 200C are not to be distinguished individually, they are collectively referred to as robot(s) 200.

In FIG. 3, a corridor B extending in the X-direction is provided on the −Y-side of the map. A branch point T1 forming a three-way intersection is provided in the middle of the corridor B. The corridor B is divided into the non-restricted area FA1, the restricted area RA1, and the non-restricted area FA2. The restricted area RA1 is located between the non-restricted areas FA1, FA2. The non-restricted area FA1 is located on the −X-side of the restricted area RA1, and the non-restricted area FA2 is located on the +X-side of the restricted area RA1. In the restricted area RA1, the number of robots that can pass simultaneously is limited to one. The restricted area RA1 corresponds to the branch point T1.

A hall H is located on the +Y-side of the restricted area RA1. The branch point T1 serves as a path from the corridor B to the hall H. The hall H includes, for example, an elevator hall in which an elevator EV is installed. The restricted area RA1 corresponds to the branch point where the hall H and the corridor B are connected. The hall H is set as the non-restricted area FA3.

A drug preparation room D is located on the +Y-side of the non-restricted area FA2 and on the +X-side of the non-restricted area FA3. The drug preparation room D serves as a loading and unloading location. That is, the drug preparation room D is a room in which transport objects are loaded onto the robot 200, or a room in which transport objects are received from the robot 200. The drug preparation room D may also be regarded as a waiting location for receiving or loading transport objects.

An entrance EN to the drug preparation room D is located at the boundary between the non-restricted area FA2 and the restricted area RA2. The robot 200 enters the drug preparation room D from the corridor B through the entrance EN. A transport object such as a pharmaceutical is then loaded onto the robot 200. An exit EX from the drug preparation room D is located at the boundary between the non-restricted area FA3 and the restricted area RA2. The robot 200 exits the drug preparation room D to the hall H through the exit EX. The robot 200 then travels to the designated delivery destination to deliver the transport object.

In FIGS. 3, 15 waypoints WP1 to WP15 are set on the map. The waypoint setting unit 122 registers a unique waypoint ID for each of the waypoints WP1 to WP15. The waypoint setting unit 122 also associates XY coordinates on the map with the waypoint IDs.

The waypoints WP1 to WP8 are set in the corridor B. The waypoints WP9 to WP12 are set in the hall H. The waypoints WP13 to WP15 are set in the drug preparation room D. The waypoints WP1, WP2, WP5, and WP6 are set in the non-restricted area FA1. The waypoints WP3, WP4, WP7, and WP8 are set in the non-restricted area FA2. The waypoints WP9 to WP11 are set in the non-restricted area FA3. The waypoints WP12 to WP15 are set in the restricted area RA2. Although no waypoint is set in the restricted area RA1, a waypoint may be set therein.

Since the corridor B is wide enough for the robots 200 to pass each other, the waypoints are set in two rows. It is herein assumed that the robots 200 travel along the corridor B keeping to the right. The waypoints WP1 to WP4 serve as passing points when traveling in the +X-direction along the corridor B. The waypoints WP5 to WP8 serve as passing points when traveling in the −X-direction along the corridor B. For example, when a planned route includes a path proceeding in the +X-direction along the corridor B, the route planning unit 115 plans the route such that the robot 200A passes the waypoints WP1, WP2, WP3, and WP4 in this order.

Since the corridor B has a width sufficient for two-way passage in both the +X-direction and the −X-direction, the waypoints WP1, WP5 are set at the same position in the X-direction but are offset in the Y-direction. This makes it possible for two robots 200 to pass each other.

The waypoints WP2, WP6 correspond to the branch point in the corridor B. Accordingly, the waypoints WP2, WP6 are set in the boundary portion between the restricted area RA1 and the non-restricted area FA1. That is, the waypoints WP2, WP6 are set near the boundary line between the restricted area RA1 and the non-restricted area FA1. In this example, the waypoints WP2, WP6 are set on the non-restricted area FA1 side of the boundary line.

The waypoints WP3, WP7 correspond to the branch point in the corridor B. The waypoints WP3, WP7 are set in the boundary portion between the restricted area RA1 and the non-restricted area FA2. That is, the waypoints WP3, WP7 are set near the boundary line between the restricted area RA1 and the non-restricted area FA2. In this example, the waypoints WP3, WP7 are set on the non-restricted area FA2 side of the boundary line.

The waypoints WP9, WP10 correspond to the branch point in the corridor B. The waypoints WP9, WP10 are set in the boundary portion between the restricted area RA1 and the non-restricted area FA3. That is, the waypoints WP9, WP10 are set near the boundary line between the restricted area RA1 and the non-restricted area FA3. In this example, the waypoints WP9, WP10 are set on the non-restricted area FA3 side of the boundary line.

The waypoints WP11, WP12 correspond to a waiting position for the elevator EV. The waypoints WP11, WP12 are set in front of the elevator EV. For example, when the robot 200 takes the elevator EV, the waypoint WP11 or WP12 is included in the route. The robot 200 then waits at the waypoint WP11 or WP12 until the elevator EV arrives.

The waypoints WP13 to WP15 correspond to waiting locations for loading and unloading transport objects. The robot 200 waits at the waypoint WP13 etc. until loading of the transport object is completed. Alternatively, the robot 200 waits at the waypoint WP13 etc. until unloading of the transport object is completed.

Referring back to FIG. 2, the right-of-way granting unit 123 grants right-of-way to the robot 200. The right-of-way is a resource that enables the robot 200 to pass through a restricted area. The right-of-way granting unit 123 grants right-of-way to each robot. The right-of-way granting unit 123 also manages the right-of-way for each restricted area.

The right-of-way granting unit 123 grants right-of-way to the robot 200 in response to a request from the robot 200. For example, when the robot 200A arrives at or near the waypoint WP2, the robot 200A transmits a request signal to the management device 100 to request right-of-way for the restricted area RA1. When the communication unit 140 of the management device 100 receives the request signal, the right-of-way granting unit 123 grants the right-of-way for the restricted area RA1 to the robot 200A. Specifically, the communication unit 140 transmits a right-of-way granting signal to the robot 200A. The right-of-way granting signal includes information such as the area ID of the restricted area where passage of the robot is permitted.

Alternatively, the right-of-way granting unit 123 may determine whether to grant right-of-way. When the robot 200A transmits its own position on the map to the management device 100, the right-of-way granting unit 123 determines whether the robot 200A has reached the front of the restricted area RA1. For example, when the robot 200A has reached the waypoint WP2, right-of-way is granted to the robot 200A. The position at which right-of-way is granted does not have to be a waypoint. Position coordinates for granting right-of-way may be set in advance. For example, when a robot 200 has reached a predetermined right-of-way granting position near a restricted area, the right-of-way granting unit 123 grants right-of-way to the robot 200. In the following description, the right-of-way granting position is described as being the same position as the waypoint closest to a restricted area. However, the right-of-way granting position may be set at position coordinates different from those of a waypoint.

The right-of-way granting unit 123 cancels the right-of-way once the robot 200 passes through the restricted area. For example, when the robot 200A passes through the restricted area RA1 and enters the non-restricted area FA2, the right-of-way granting unit 123 cancels the right-of-way of the robot 200A for the restricted area RA1. Alternatively, the robot 200A may transmit a cancellation signal to the management device 100 based on its own position. A waypoint for cancelling the right-of-way may be set.

For example, it is herein assumed that the route planning unit 115 plans a route such that the robot 200A moves along a route PH1 and the robot 200B moves along a route PH2. In this case, if the robots 200A, 200B simultaneously enter the restricted area RA1, there is a risk that the robots 200A, 200B will face each other within the restricted area RA1. As a result, the robots 200A, 200B may become unable to pass through the restricted area RA1 or may need to detour. Therefore, the restricted area RA1 is provided to restrict passage of the robots 200. This allows multiple robots 200 to travel efficiently.

The priority setting unit 124 sets priorities of right-of-way. Specifically, the priority is a resource for determining the order of passage through a restricted area. The priority is data that is set for each restricted area. For example, the robot 200 having the highest (first) priority can enter the restricted area. When multiple rights-of-way are granted for one restricted area, priorities are assigned as first, second, and so on, according to the number of robots having right-of-way. The robot with the highest priority is assigned the first priority. Multiple robots 200 pass through the restricted area in order according to their priorities. The priority setting unit 124 assigns the priority at the time when right-of-way is granted. That is, a robot 200 that has reached the right-of-way granting position is assigned a priority together with right-of-way.

The update unit 125 updates the priorities. When the robot 200 having the first priority passes through a restricted area, its right-of-way and priority are revoked. The update unit 125 increments the priorities of the remaining robots by one. Accordingly, when the right-of-way of the first robot 200 is canceled, the priority of the second robot is updated to first, and the priority of the third robot 200 is updated to second. The update unit 125 increments the priorities at the time when the right-of-way granting unit 123 cancels right-of-way. Multiple robots 200 that have been granted right-of-way can pass through the restricted area in order according to their priorities.

The communication unit 140 transmits various types of data and signals to each of the robots 200. For example, when a robot 200 travels to the front of a restricted area, the communication unit 140 transmits data of right-of-way and priority to the robot 200. The communication unit 140 also transmits to each robot 200 the priorities updated by the update unit 125. Each robot 200 waits at the front of the restricted area if its priority is second or later. The robot 200, whose priority has become first, enters the restricted area.

For example, the priority setting unit 124 may assign a priority at the time when right-of-way is granted. The priority setting unit 124 assigns priorities to the robots 200 in the order in which they arrive near the restricted area.

The priority setting unit 124 may set priorities based on transport object information, task information, etc. For example, the priorities are updated such that a robot 200 transporting a priority transport object can pass through the restricted area with precedence. The following will describe the case in FIG. 3 where the robot 200A arrives at the waypoint WP2, which is a right-of-way granting position, before the robot 200B arrives at the waypoint WP10, which is also a right-of-way granting position. It is herein assumed that the robot 200A is transporting a normal transport object, while the robot 200B is transporting a priority transport object that should be transported with precedence over the transport object of the robot 200A.

First, when none of the robots 200A to 200C have been granted right-of-way or assigned a priority, the robot 200A arrives at the waypoint WP2. The right-of-way granting unit 123 grants right-of-way to the robot 200A. The priority setting unit 124 sets the priority of the robot 200A to first. Suppose that the robot 200B arrives at the waypoint WP10 before the robot 200A enters the restricted area RA1. At that time, the right-of-way granting unit 123 grants right-of-way to the robot 200B, and the priority setting unit 124 sets the priority of the robot 200B to first. The update unit 125 then updates the priority of the robot 200A from first to second. In other words, the priority of the robot 200A is lowered by one.

In this way, the priority setting unit 124 performs an interrupt process such that the robot 200B, which is transporting a priority transport object, can pass through the restricted area RA1 ahead of the robot 200A. The interrupt process refers to a process in which a robot that has been newly granted right-of-way is allowed to pass through a restricted area ahead of a robot that was previously granted right-of-way. The priority setting unit 124 defines a robot that has already been granted right-of-way as a granted robot. Accordingly, the interrupt process refers to assigning a higher priority to a newly granted robot than to a granted robot.

When the priority setting unit 124 performs the interrupt process, the update unit 125 lowers the priority of the robot 200A, which had been set to first, to second. In this way, the robot 200B, which is transporting a priority transport object, passes through the restricted area RA1 along the route PH2. At this time, the robot 200A, whose priority is second, waits in front of the restricted area RA1. That is, the robot 200A stops at a position between the waypoint WP2 and the boundary line between the restricted area RA1 and the non-restricted area FA1. Although the robot 200A has been granted right-of-way, it cannot enter the restricted area RA1 because its priority is second.

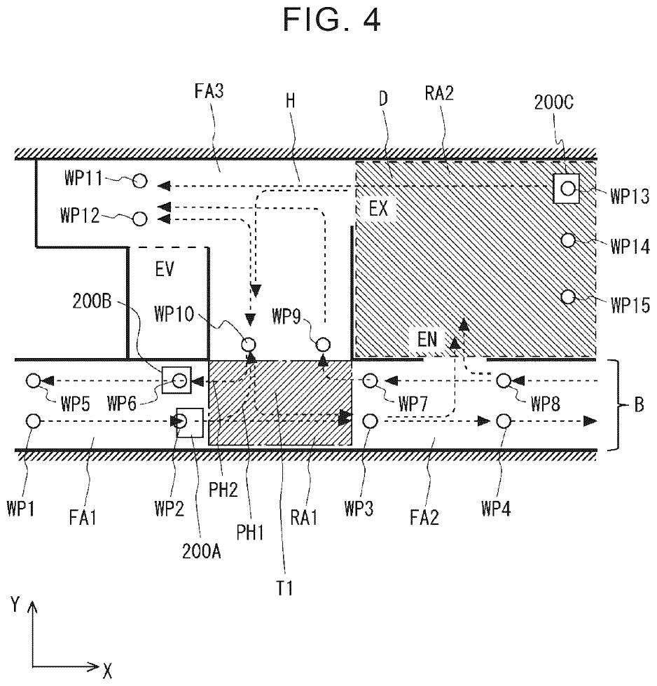

As shown in FIG. 4, after the robot 200B passes through the restricted area RA1, the update unit 125 revokes the right-of-way and priority of the robot 200B. The update unit 125 then raises the priority of the robot 200A from second to first. As a result, the robot 200A enters the restricted area RA1.

At the time when the robot 200A enters the restricted area RA1, the robot 200B has traveled to near the waypoint WP6 in the non-restricted area FA1. In other words, the robot 200B is no longer in the restricted area RA1. Therefore, the robot 200A can pass through the restricted area RA1 along the route PH1 without facing or interfering with the robot 200B. In this way, the robot 200B can preferentially transport the priority transport object. Furthermore, multiple robots 200 can travel efficiently. As a result, the overall task execution efficiency is less likely to decrease.

If the robot 200A has already entered the restricted area RA1 when the robot 200B arrives at the right-of-way granting position, the priority of the robot 200B is set to be after that of the robot 200A. In other words, the interrupt process does not apply when the robot 200A is already passing through the restricted area RA1.

The priority setting unit 124 may set priorities based on transport object information. For example, the priority can be set according to the type or size of the transport object. Alternatively, the priority setting unit 124 may set priorities based on robot information, task information, etc. In other words, the priority setting unit 124 may assign a higher priority to the robot 200B that has arrived later at a right-of-way granting position to allow the robot 200B to pass preferentially. The update unit 125 then lowers the priority of the robot 200A. In this way, the robot 200B that has arrived later at a right-of-way granting position can pass through the restricted area RA1 before the robot 200A.

For example, in task information, the priority setting unit 124 sets priorities such that the priority of a robot transporting a transport object is higher than that of a robot that has completed transport. The priority of a robot 200 executing a task may be set higher than that of a robot 200 not executing a task. Alternatively, the priority setting unit 124 may set priorities according to the priority of the tasks. The priority setting unit 124 assigns a higher priority to a robot performing a task with a higher priority. The priorities are set based on the urgency or importance of tasks etc.

For example, the priority setting unit 124 may determine priorities or levels of priority according to the type of transport object, type of task, time of day, congestion conditions in the facility, etc. Each task or transport object may be associated with priority data. Alternatively, a robot itself may be assigned a priority. A robot dispatched in response to an emergency call etc. may be assigned the highest priority. A task for traveling to a charger for charging may be assigned a low priority. The priority may differ between the trip to the destination and the return trip. The priorities may be set according to the actions to be taken by the robot. The priority may be classified into multiple levels, such as one to five, or may be set using scores calculated from various data. When multiple robots have the same priority level, the priorities are set in the order in which right-of-way is granted.

The priorities are set for the robots 200 based on task information, transport object information, robot information, etc. The priority setting unit 124 compares the priority of a newly granted robot with that of a granted robot, and sets the priorities accordingly. For example, a robot performing a high priority task is given a high priority. When a delivery deadline for a transport object is set in the transport object information, the robot with the shorter remaining time until the deadline may be given a higher priority. The priorities may be set based on the real-time task management status of the task management unit. The priority may be varied according to the task executed by a newly granted robot 200. Specifically, by comparing the task of a newly granted robot 200 with the task of a granted robot, the priority setting unit 124 may determine whether to perform the interrupt process.

Tasks requiring right-of-way are not limited to transport tasks and may include cleaning tasks etc. In other words, “passage” when right-of-way is granted also includes temporary stays. Accordingly, when a cleaning task is assigned to a robot 200, the robot 200 cannot enter the restricted area to perform the cleaning task until it is granted right-of-way.

The priorities may also be set according to the congestion conditions in the facility. For example, the management device 100 may determine the degree of congestion based on images from the camera 500 etc. A higher priority may be set for a robot 200 whose destination is a highly congested location. Alternatively, a lower priority may be set for a robot 200 whose destination is a highly congested location.

The right-of-way granting unit 123 revokes the right-of-way for a robot 200 that has exited a restricted area. The priority setting unit 124 cancels the priority assigned to a robot 200 whose right-of-way has been revoked. Alternatively, the right-of-way and priority may be revoked a certain time after the robot 200 enters the restricted area.

When right-of-way is newly granted to a robot while right-of-way has already been granted to multiple robots, the priority of the newly granted robot may be set to any value. An example will be described in which right-of-way is granted to a third robot 200C when two robots 200A, 200B have already been granted right-of-way.

First, suppose the robots 200A, 200B have already been granted right-of-way, with the robot 200A having first priority and the robot 200B having second priority. When right-of-way is newly granted to the robot 200C, the robot 200C may be assigned first priority. In this case, the update unit 125 updates the priority of the robot 200A to second and that of the robot 200B to third.

Alternatively, when the robots 200A, 200B have already been granted right-of-way and right-of-way is newly granted to the robot 200C, the robot 200C may be assigned second priority. The update unit 125 then updates the priority of the robot 200B to third. In other words, the priority of the robot 200A remains first and is not updated.

Alternatively, when the robots 200A, 200B have already been granted right-of-way and right-of-way is newly granted to the robot 200C, the robot 200C may be assigned third priority. In other words, the priority of the robot 200A remains first, and the priority of robot 200B remains second.

When right-of-way is granted to multiple robots at the same time, the priority setting unit 124 or the update unit 125 may completely reorder the priorities.

At least one restricted area may be assigned a maximum number of robots that can pass therethrough simultaneously. For example, in FIG. 3, the restricted area RA2 serves as a waiting location for loading and unloading transport objects. The restricted area RA2 includes three waiting spots, which are the waypoints WP13, WP14, and WP15. In this case, three robots 200 can pass simultaneously. Alternatively, four or more robots may be permitted to pass simultaneously. When a higher priority is assigned to a newly granted robot 200, the priorities and right-of-way of robots 200 with lower priorities may be revoked.

When multiple restricted areas are set on a map, different priorities may be set for each restricted area. In other words, when there are multiple restricted areas, the rules for determining priorities may be different for each restricted area. For example, in FIG. 3, for the restricted area RA2 corresponding to a loading and unloading location, the priority setting unit 124 sets priorities according to the type or importance of the transport object. For the restricted area RA1 located in a corridor, the priority setting unit 124 sets priorities according to the type of robot. For example, the priority setting unit 124 may assign higher priority to robots capable of moving at higher speed.

In one or more restricted areas, the priorities may be set for each robot. In another one or more restricted areas, the priorities may be set according to the type of task, such as a transport task, a cleaning task, or a security task. In still another one or more restricted areas, the priorities may be set according to the type of transport object.

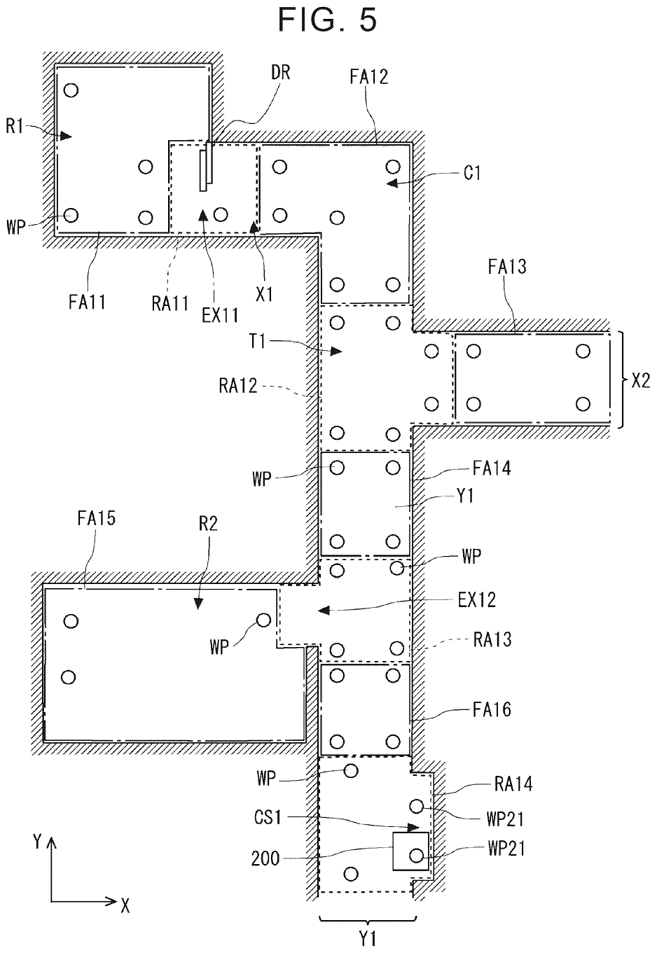

Restricted areas and non-restricted areas will now be described with reference to FIG. 5. FIG. 5 shows a map on which restricted areas and non-restricted areas are established. As shown in FIG. 5, four restricted areas RA11 to RA14 and six non-restricted areas FA11 to FA16 are provided on the map. A corridor Y1 extending in the Y-direction is provided on the map. Corridors X1, X2 extending in the X-direction are connected to the corridor Y1. The corridors Y1, X1, and X2 are wide enough for robots to pass each other. The corridors X1, Y1 are connected by a right-angled corner C1. The corridors X2, Y1 are connected by a branch point T1. A room R1 is located at the end of the corridor X1 in the −X-direction. A door DR is installed at the entrance/exit EX1 of the room R1. Waypoints WP are set on the map. For example, the waypoints WP are arranged in two rows in the corridors X1, X2. The waypoints WP are arranged in two rows in most of the corridor Y1.

The room R1 is set as a non-restricted area FA11, and the entrance/exit EX11 of the room R1 and its surrounding area are set as a restricted area RA11. The door DR at the entrance/exit EX11 narrows the corridor width. Therefore, the robots 200 cannot pass each other. By setting the entrance/exit EX11 and its surrounding area as the restricted area RA11, multiple robots 200 can efficiently pass through the entrance/exit EX11. For example, when a robot 200 traveling in the +X-direction is passing through the restricted area RA11, a robot 200 traveling in the −X-direction cannot enter the restricted area RA11. Therefore, the restricted area RA11 in which passage of the robots 200 is restricted is set around the door DR where the corridor width is narrow. In this way, multiple robots 200 can efficiently pass through the entrance/exit EX11.

The corridor X2 is set as a non-restricted area FA13. The branch point T1 connecting the corridors Y1, X2 and its surrounding area are set as a restricted area RA12. At the branch point T1, the paths of multiple robots 200 may overlap or intersect each other. If two robots 200 enter the branch point T1 from different directions, they may face each other and will be unable to pass. Therefore, by setting the branch point T1 and its surrounding area as the restricted area RA12, multiple robots 200 can efficiently pass through the branch point T1. A room R2 is set as a non-restricted area FA15, and the entrance/exit EX12 of the room R2 and its surrounding area are set as a restricted area RA13. The region around the entrance/exit EX12 corresponds to a branch point leading from the corridor Y1 in the Y-direction toward the X-direction. When a robot 200 turns in the −X-direction at the entrance/exit EX12, it can enter the room R2.

The corridor width becomes narrow at the entrance/exit EX12. By setting the entrance/exit EX12 and its surrounding area as the restricted area RA13, multiple robots 200 can efficiently pass through the entrance/exit EX12. The region between the restricted areas RA11, RA12 is set as a non-restricted area FA12. In this example, the corner C1 is the non-restricted area FA12. In the corridor Y1, the region between the restricted areas RA12, RA13 is set as a non-restricted area FA14. A portion of the straight section of the corridor Y1 is the non-restricted area FA14.

A charging location CS1 is located at the end of the corridor Y1 in the −Y-direction. A region projecting in the +X-direction from the corridor Y1 serves as the charging location CS1. A charger for charging the batteries of the robots 200 is installed in the charging location CS1. The charging location CS1 serves as a waiting location where the robots 200 remains for a long period of time. The charging location CS1 is set as a restricted area RA14. A waypoint WP21 provided in the charging location CS1 corresponds to the location of the charger. The waypoint WP21 is located in a widened section of the corridor Y1. When a robot 200 remains at the waypoint WP21 during charging, the robot 200 may protrude into the corridor. Since the effective corridor width becomes narrower while a robot 200 remains at the waypoint WP21, the charging location CS1 and its surrounding area are set as the restricted area RA14. The waiting location of the robots 200 is set as the restricted area RA14.

As described above, branch points of corridors, corridors narrower than a prescribed width, or waiting locations of autonomous moving objects are set as restricted areas. As a result, the robots 200 can travel efficiently. However, the restricted areas are not limited to these locations. Other examples of the restricted areas may include an elevator hall, a hall, a room, an entrance/exit, a location for receiving transport objects, a loading location, an unloading location, a waiting location, and a charging location. In FIG. 5, restricted areas and non-restricted areas are arranged alternately. However, restricted areas may be arranged consecutively. That is, a restricted area may be located adjacent to another restricted area. In such a case, the restrictions may differ between the adjacent restricted areas. For example, simultaneous passage may be prohibited in one restricted area, while single-lane passage may be prohibited in an adjacent restricted area. A maximum number of moving objects that can simultaneously pass through a restricted area may be set.

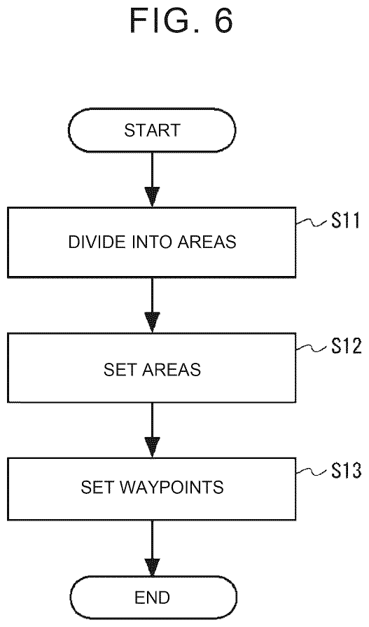

FIG. 6 is a flowchart illustrating a management method according to the present embodiment. The division unit 120 divides the map into a plurality of areas (S11). Specifically, the division unit 120 reads map information from the map information storage unit 111. The map information may be image data such as architectural drawing data. The area setting unit 121 sets restricted areas and non-restricted areas on the map based on the divided areas (S12). The area setting unit 121 sets at least one restricted area and at least one non-restricted area. The area setting unit 121 may assign attributes to the restricted and non-restricted areas. A restricted area may be set in association with the boundary position between areas. For example, the area setting unit 121 may set the boundary portion between an area representing one room and an area representing another room as a restricted area. Alternatively, the area setting unit 121 may set the boundary portion between an area representing a corridor and an area representing a room as a restricted area. The area setting unit 121 may set the boundary portion between an area representing a corridor in the X-direction and an area representing a corridor in the Y-direction as a restricted area. Since the boundary between two corridors extending in different directions corresponds to an intersection or branch point where the two corridors merge or diverge, this area is set as a restricted area.

The waypoint setting unit 122 sets multiple waypoints on the map (S13). As shown in FIG. 5, the waypoint setting unit 122 sets multiple waypoints in the restricted area. The waypoint setting unit 122 also sets multiple waypoints in the non-restricted area. Preferably, the waypoint setting unit 122 sets waypoints in the boundary portion between the restricted and non-restricted areas. For example, when the waypoint setting unit 122 sets a waypoint in a non-restricted area near a restricted area, this waypoint serves as a waypoint for a robot to wait before entering the restricted area.

The management device 100 or the robots 200 may use a machine learning model, such as deep learning, for route planning and driving control. A machine learning model, such as deep learning like a recurrent neural network (RNN) or a convolutional neural network (CNN), may also be used for detecting surrounding objects.

Part or all of the processing executed by the robot 200 or the management device 100 described above may be implemented as a computer program. Such a program can be stored using various types of non-transitory computer-readable media and supplied to a computer. Non-transitory computer-readable media include various types of tangible storage media. Examples of non-transitory computer-readable media include magnetic recording media (e.g., flexible disks, magnetic tapes, hard disk drives), magneto-optical recording media (e.g., magneto-optical disks), compact-disc read-only memory (CD-ROM), compact disc-recordable (CD-R), compact disc-rewritable (CD-R/W), and semiconductor memory (e.g., mask ROM, programmable ROM (PROM), erasable PROM (EPROM), flash ROM, and random access memory (RAM)). The program may also be supplied to a computer via various types of transitory computer-readable media. Examples of transitory computer-readable media include electrical signals, optical signals, and electromagnetic waves. Transitory computer-readable medium can supply a program to a computer via wired communication channels such as electric wires and optical fibers, or via wireless communication channels.

The present disclosure is not limited to the above embodiment, and may be modified as appropriate without departing from the spirit and scope of the disclosure.

What is claimed is:

1. A management system comprising a server configured to manage a plurality of autonomous moving objects that travels within a facility, wherein the management system is configured to
divide a map of the facility into a plurality of areas based on map information indicating the map,
set, based on the areas, at least one restricted area and at least one non-restricted area on the map, and
in the restricted area, permit passage of an autonomous moving object to which right-of-way that permits passage through the restricted area is granted, and restrict passage of an autonomous moving object to which the right-of-way is not granted.

2. The management system according to claim 1, wherein the restricted area is set in association with a boundary position between the areas.

3. The management system according to claim 2, wherein a branch point of a corridor, a corridor having a width smaller than a predetermined value, or a waiting location of the autonomous moving objects is set as the restricted area.

4. The management system according to claim 1, wherein the map is divided into the areas by a Voronoi tessellation.

5. A method for managing a plurality of autonomous moving objects that travels within a facility by using a computer, the method comprising causing the computer to
divide a map of the facility into a plurality of areas based on map information indicating the map,
set, based on the areas, at least one restricted area and at least one non-restricted area on the map, and
in the restricted area, permit passage of an autonomous moving object to which right-of-way that permits passage through the restricted area is granted, and restrict passage of an autonomous moving object to which the right-of-way is not granted.
